(19) United States
(12) Patent Application Publication
(10) Pub. No.: US 2016/0368225 A1
(43) Pub. Date: Dec. 22, 2016

(54) METHOD OF MANUFACTURING AND ASSEMBLING PRECISION COMPONENTS OF 3D PRINTING SYSTEM

(71) Applicant: 3D Systems, Inc., Rock Hill, SC (US)

(72) Inventor: Michael E. Jones, Wilsonville, OR (US)

(73) Assignee: 3D Systems, Inc.

(21) Appl. No.: 15/143,307

(22) Filed: Apr. 29, 2016

Related U.S. Application Data
(60) Provisional application No. 62/181,716, filed on Jun. 18, 2015.

(51) Int. Cl. B29C 67/00

(52) U.S. Cl. CPC B29C 67/0092; B29C 67/0051; B33Y 30/00

(57) ABSTRACT

A 3D printing system comprises an X-axis base for positioning stationarily relative to movable Y-axis and Z-axis components. The X-axis base has first and second sides and a workpiece opening. A Z-axis base is secured to the X-axis base's second side adjacent the opening. The Z-axis base is configured to support a model being printed and to controllably move the model in a Z direction through the opening. There is a movable arm member slidingly coupled to the second side of the X-axis base and extending over the first side of the X-axis base. The movable arm is movable in an X direction. A Y-axis carriage is slidingly coupled to the movable arm member and is movable in a Y direction. A printhead coupled to the Y-axis carriage is controllably movable in the X and Y directions to print successive layers of the model supported by the Z-axis base.

### CROSS REFERENCE TO RELATED APPLICATION

This application claims the benefit of U.S. Provisional Patent Application No. 62/181,716, filed Jun. 18, 2015, which is hereby incorporated by reference.

### BACKGROUND

In a 3D printing system, there are multiple components that must cooperate together to allow a model to be built (or “printed”) at any point within the system's specified build space (build envelope). As 3D printing systems have increased in scale, their corresponding build spaces have ever greater specified sizes. As a result, it has been become much more time-consuming, expensive and difficult to ensure that the precision components of these systems, including movable components and stationary components, are manufactured, assembled and calibrated in ways to ensure sufficient precision and accuracy in 3D printing operations.

### SUMMARY

Described below are representative implementations of methods and 3D printing systems that address problems in the prior art.

According to a method implementation, assembling precision components of a 3D printing system comprises providing an X-axis base configured for positioning stationarily relative to movable Y-axis and Z-axis components. The X-axis base has a first side, an opposite second side and at least one datum transfer through opening extending from the second side to the first side. The datum transfer opening has a generally planar peripheral surface on the second side defining an XY reference plane. The method also comprises providing a cover member on the second side to at least partially cover the datum transfer through opening, with the cover member fitting against at least a portion of the generally planar peripheral surface of the datum transfer through opening. The cover member and a wall of the opening together define a bore in the X-axis base. The method also comprises placing a calibration member having a predetermined dimension in the bore. The calibration member is sized to contact the cover member and project above the first side of the X-axis base. By positioning a second component to contact the calibration member, the second component is thereby located at a position spaced from the XY reference plane by the known dimension.

According to another method implementation, assembling precision components of a 3D printing system comprises providing an X-axis base configured to be positioned stationarily relative to movable Y-axis and Z-axis components in an assembled 3D printing system. The X-axis base has a first side, an opposite second side and a workpiece opening defined therein to extend between the first and second sides. The method also comprises securing the X-axis base for machining in a single setup with the second side exposed for machining, and while the X-axis base is secured in the single set up, machining Z-axis base mounting locations at predetermined positions adjacent the workpiece opening, the Z-axis base mounting locations being configured for mounting a Z-axis base that supports a model being printed and moves the model relative to the X-axis base in a Z direction, and machining at least one rail location defining an X direction along which a movable member can be moved to cause a printhead coupled to the movable member to print in the X direction. Because at least the X direction and the Z direction are defined while the X-axis is in the single setup, the potential loss of precision in positioning due to tolerance stack-up is thereby reduced.

According to another implementation, a 3D printing system comprises an X-axis base, a Z-axis base, a movable arm member, a Y-axis carriage and a printhead. The X-axis base is configured to be positioned stationarily relative to movable Y-axis and Z-axis components. The X-axis base has a first side, an opposite second side and a workpiece opening defined therein to extend between the first and second sides. The Z-axis base is secured to the second side of the X-axis base adjacent the workpiece opening. The Z-axis base is configured to support a model being printed and to controllably move the model in a Z direction through the workpiece opening in the X-axis base. The movable arm member is slidingly coupled to the second side of the X-axis base and extends over the first side of the X-axis base, the movable arm being movable in an X direction. The Y-axis carriage is slidingly coupled to the movable arm member and movable in a Y direction. The printhead is coupled to the Y-axis carriage and is controllably movable in the X direction by movement of the movable member and in the Y direction by movement of the Y-axis carriage to print successive layers of the model supported by the Z axis base.

### BRIEF DESCRIPTION OF DRAWINGS

FIG. 1 is an exploded perspective view of a portion of a 3D printing system that shows major precision components and how they are interrelated.

FIG. 2 is a perspective view showing some of the major precision components of FIG. 1 as assembled together.

FIGS. 3A-3J are orthogonal and sectional views showing the X-axis base of the 3D printing system of FIG. 1.

FIG. 4 is a perspective view of the X-axis base of FIG. 1 showing its lower side after fabrication, e.g., being machined in a single set up.

FIG. 5 is a top plan view of the X-axis base showing its upper side.

FIGS. 6A-6E are orthogonal and section views of an X-axis cross member of the 3D printing system of FIG. 1.

FIGS. 7A and 7B are perspective views of the X-axis cross member.

FIGS. 8A-8G are perspective and orthogonal views of an X-axis drive frame of the 3D printing system of FIG. 1.

FIG. 9 is a perspective view in section showing the X-axis cross member positioned relative to the X-axis base during a calibration operation using datum transfer openings in the X-axis base and calibration members in the openings.

FIG. 10A is an elevation view showing bosses on the X-axis cross member in contact with the calibration members of FIG. 9, and also showing the Y-axis carriage, printhead and planerizer blade mounted to the X-axis carriage positioned over the X-axis base.

FIG. 10B is a section view in elevation showing the X-axis cross member, a planerizer roller mounted to the X-axis cross member, and a build plate on the Z-axis stage in relation to the X-axis base.

FIGS. 11A-11D are orthogonal views of a Z-axis base of the 3D printing system of FIG. 1.

FIGS. 12A-12D are perspective and orthogonal views of a Z-axis base of the 3D printing system of FIG. 1.

FIGS. 13A-13G are orthogonal and perspective views of a Y-axis carriage of the 3D printing system of FIG. 1.

### DETAILED DESCRIPTION OF PREFERRED EMBODIMENTS

Described below are methods of manufacturing and assembling 3D printing systems that allow for highly precise and accurate 3D printing, but reduce the time and skill required for manufacturing, assembly and calibration. The time and labor savings translate into reduced costs and a much more competitive 3D printing system for today's growing market.

In addition to having highly accurate and highly precise printing capabilities, the resulting 3D printing systems are also robustly design for a long product life and easier maintenance and repairs.

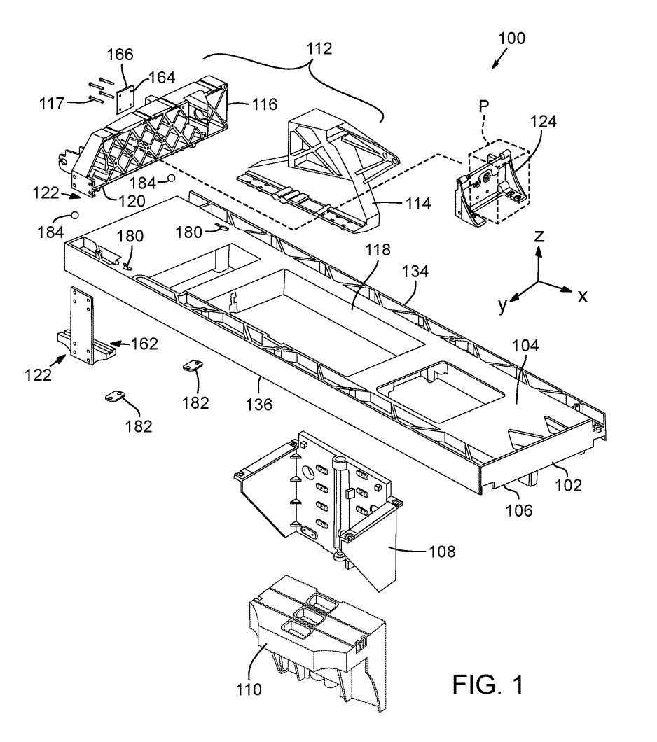

FIG. 1 is an exploded perspective view showing some of the major components of a 3D printing system 100. The system 100 includes a frame 102, called an X-axis base, to which other components are assembled. The X-axis base 102 has a generally rectangular shape with an upper side 104 (also referred to as a first side) and an opposite lower side 106. Several openings, including the opening 118, are defined in the X-axis base 102, as discussed below in greater detail.

As indicated in FIG. 1, an X-axis of the system is defined to extend parallel to one longer edge (or pair of longer edges) of the X-axis base 102. Correspondingly, a Y-axis extends in a direction perpendicular to the X-axis, and generally parallel to one shorter edge (or pair of shorter edges) of the X-axis base 102. Details of the coordinate system as it specifically relates to precision components and their movements are discussed below.

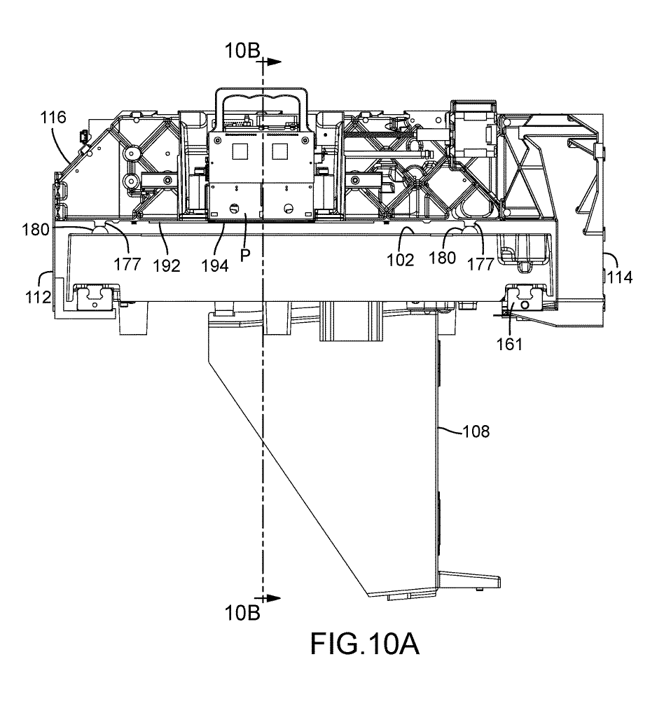

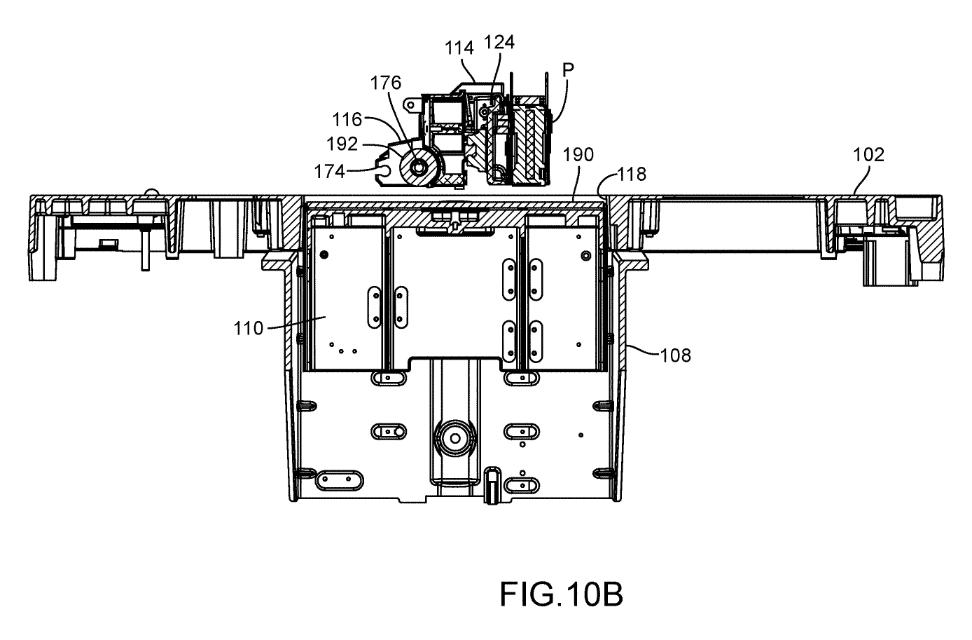

As shown in FIG. 1, there is another component 108, called a Z-axis base, which is configured to mount to the lower side 106 of the X-axis base 102 along a portion of the periphery of the opening 118. The Z-axis base 108 can be mounted to the X-axis base 102 using any suitable approach, such as, e.g., threaded fasteners (not shown). A Z-axis for the system 100 extends perpendicular to the X-axis base 102 and through the opening 118. The Z-axis base 108 supports a movable Z-axis stage 110 for vertical or up-and-down movement in the direction of the Z axis. A build plate 190 (FIG. 10B), which has been omitted from FIG. 1 for clarity, can be placed on the Z-axis stage 110 to serve as a base upon which a 3D printed model is built during a 3D printing session.

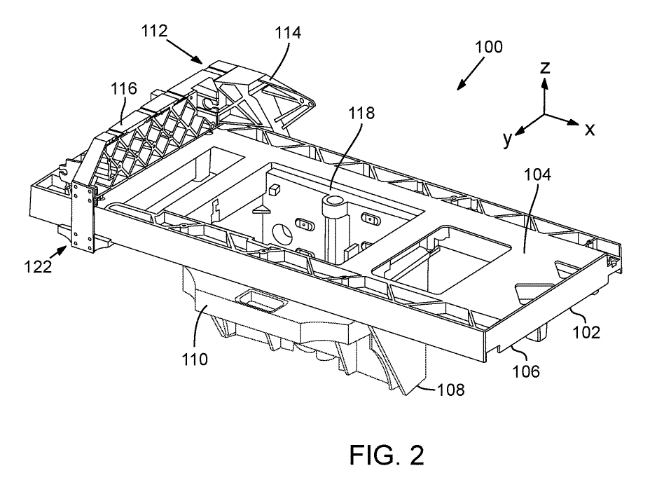

A laterally movable member 112, which is called a movable X-axis member, includes an X-axis drive member 114 and an X-axis cross member 116 (which are shown assembled together in FIG. 2). The movable X-axis member 112 is movable back and forth in the X direction. The movable X-axis member 112 is shaped to slidingly engage at least one rail on the lower side 106 as described below in greater detail.

In the illustrated implementation, the X-axis cross member 116 is adjustably attached to the X-axis drive member 114, such as with fasteners 117 extending through a nut plate 166 and cross member 116, and received in the X-axis drive member 114. The X-axis cross member 116 has a distal end 120 with an attached flexure assembly (or mount) 122 that slidingly engages a side of the X-axis base 102. Further details of the movable X-axis member 112 are discussed below.

A Y-axis carriage 124 is configured for attachment to the movable X-axis member, either directly or indirectly, with fasteners.

FIG. 2 is a perspective view of the X-axis base 102 with the Z-axis base 108 in its installed position suspended from the lower side 106 and also showing the Z-axis stage 110 mounted for movement relative to the Z-axis base 108. As also shown in FIG. 2, the movable X-axis member 112 is shown mounted for movement in the X direction with the X-axis drive frame 114 slidingly engaged with a rail (not shown) and the attached X-axis cross member 116 extending perpendicularly. In the illustrated implementation, the distal end 120 is connected to the X-axis base 102 by the flexure mount 122.

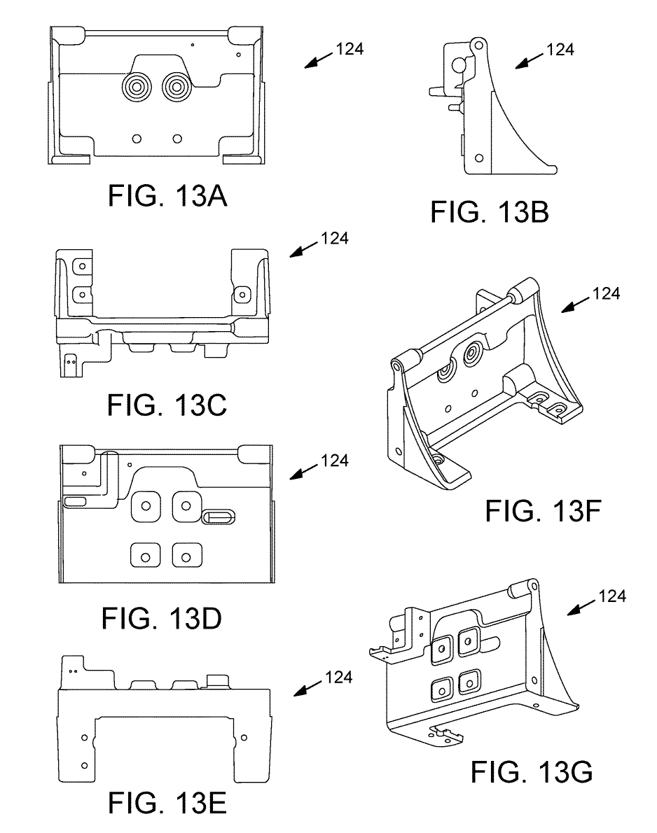

In operation, the Z-axis stage 110 is controlled to move in the Z direction or vertically, and the movable X-axis arm 112 is controlled to move in the X direction, according to specific instructions necessary to complete a desired build sequence. The Y-axis carriage 124 supports other components, such as a print head assembly (as shown schematically at P in FIG. 1) containing at least a build material and in some cases a support material, in executing movements in the Y direction sufficient to carry out build operations within the entire build envelope. Additional views of the Y-axis carriage 124 are shown in FIGS. 13A-13G.

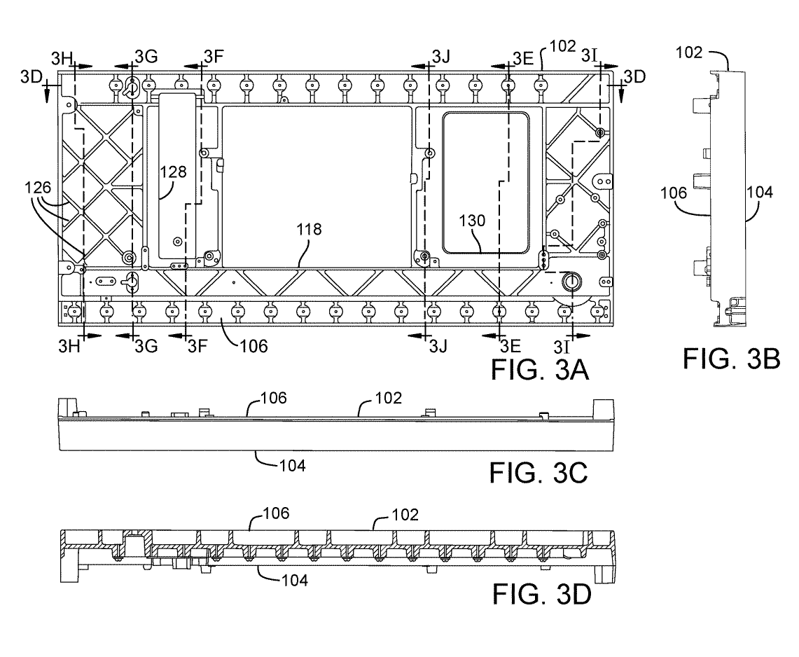

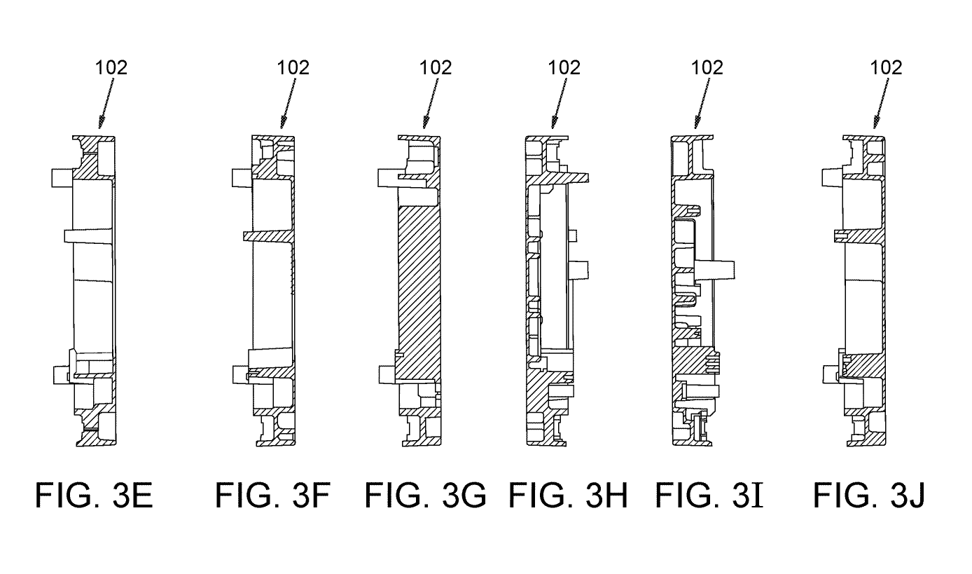

FIGS. 3A-3J show the construction of the X-axis base 102 in more detail. In some implementations, the X-axis base 102 is formed as a casting and has webs, such as the webs 126, and other similar structural features to provide sufficient rigidity yet maintain an appropriate weight for the component. In addition to the opening 118 described above, the X-axis base can be provided with other openings, such as a waste opening 128 and an opening 130 as shown and described in further detail below.

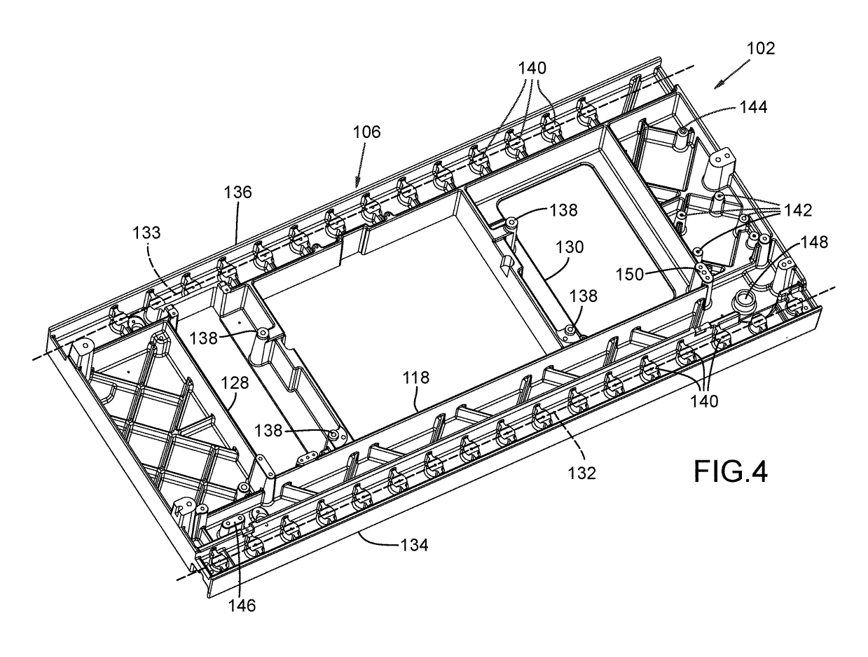

FIG. 3A and the perspective view of FIG. 4 show the lower side 106 of the X-axis base 102. According to one method of fabrication and assembly, the X-axis base 102 is formed by casting and then set up and secured in a fixture (not shown) to expose the lower side 106 for subsequent steps, such as machining steps. While the X-axis base 102 is secured in the fixture, the casting is machined to define a first rail location 132 that extends in the X direction (which is also generally parallel to each of the edges 134, 136). In addition, the casting is machined to define a second rail location 133 that also extends in the X direction. In the illustrated implementation, the rail locations 132, 133 are formed along respective rows of spaced apart protruding bosses 140, three of which are specifically identified for each rail location.

Also while the X-axis base 102 is secured in the fixture, the casting is machined to define attachment locations 138 adjacent the opening 118 for attaching the Z-axis base 108 to the X-axis base 102. In the illustrated implementation, there are four attachment locations 138, and threaded fasteners (not shown) are used to attach the Z-axis base 108 to the X-axis base 102.

The approach of defining the rail and attachment locations while the X-axis base is secured and without changing its reference location between operations is referred to herein as using a “single set up.” Positioning the defined locations substantially on one side of the X-axis base 102, thereby allowing the X-axis base 102 casting to be machined predominately from one side, is referred to herein as a “single side” approach.

Similarly, as best shown in FIG. 4, one or more of the following attachment locations can be defined, such as by machining the X-axis base 102 while it remains secured in the fixture: (1) one or more X-axis motor mount locations 142; (2) an X-axis motor belt tension spring location 144; (3) an X-axis belt tensioner location 146; (4) a compound pulley location 148; and (5) a compound pulley bracket location 150.

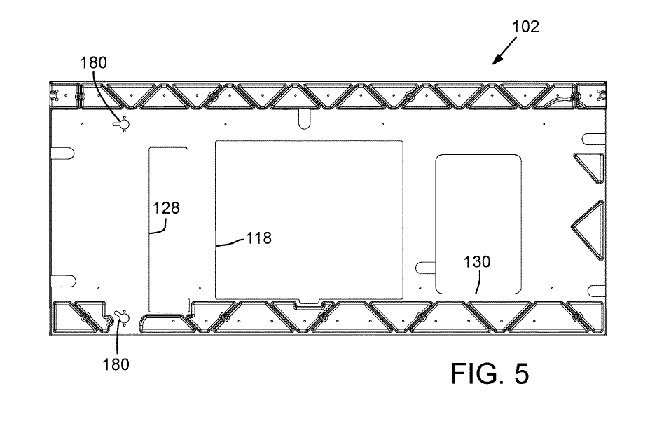

As shown in FIG. 4 and, from the upper side, in FIG. 5, the X-axis base 102 can be formed with one or more datum transfer openings 180 by which a reference position on one side (e.g., on the lower side 106) can be transferred to an opposite side (e.g., to the upper side 104). For example, in the implementation shown in FIG. 5, the X-axis base is formed with two datum transfer openings 180. These openings 180 are formed at positions with precisely determined X, Y and Z coordinates, preferably during a single set up machining operation. Thus, the periphery of each datum transfer opening 180 on the lower side 106 has a Z axis position that can be determined with high precision. The precision of these Z axis positions can be transferred to the upper side 104 with ease during an assembly operation and without requiring precision equipment by: (1) fitting the datum transfer openings 180 from the lower side 106 with cover members 182 (FIG. 1) to form a “pocket” or a recess; (2) rotating the X-axis base 102 such that its upper side 104 is facing upwardly to expose the recesses; and (3) for each recess, placing a calibration member 184 of a known dimension in the recess and against the cover member 182. In this way, the position of the periphery of the datum transfer opening 180 from the lower side 106 can be referenced, and thus the precision of that location can be transferred to the upper side 104. One suitable calibration member 184, such as is shown in FIG. 1, is a sphere of a known dimension that can fit in the opening 180. In some implementations, a conventional ball bearing can be used as the calibration member 184.

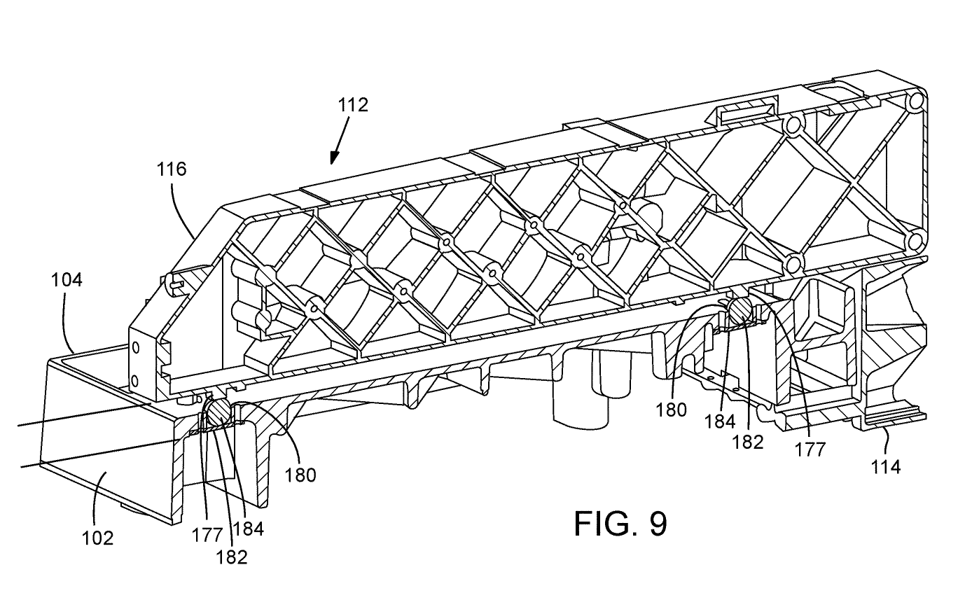

FIG. 9 is a perspective view showing portions of the X-axis base 102 and the movable member 112 during assembly. Specifically, FIG. 9 shows the calibration members 184 resting on respective cover members 182 and protruding out of their respective recesses and above the level of the upper side 104 of the X-axis base 102. The X-axis cross member 116 is shown resting in contact on the protruding calibration members 184. Thus, the correct position of the X-axis cross member 116 can be determined very nearly to the same precision of the openings 180, with the result that the X-axis cross member 116 can be maintained parallel to the X-axis stage 102 with high precision, as desired. Optionally, the specific calibration members 184 can be retained with the 3D printing system with which they were used for initial assembly in the event that recalibration of positions is required over the life of the system.

As an alternative that may be acceptable in some implementations, a precision spacing plate (not shown) can be placed on the X-axis base 102 and then the X-axis cross member 116 can be rested upon it to determine its correct position and alignment.

Referring to FIGS. 1, 2 and 8A-8G, the X-axis drive frame 114 can also be formed from a casting and then machined to define predetermined locations. The X-axis drive frame 114 is designed to move along the X-axis base 102 in the X-direction and to support other components. Specifically, the X-axis drive frame 114 has a body 152 with a lower part 154 and an upper part 156. The lower part 154 engages a rail in the rail location 132 on the lower side 106 to allow the X-axis drive frame 114 to be slid back and forth. In the illustrated implementation, the lower part 154 is flange-shaped and has two bearing mounts 159 shaped to receive linear bearings 161. In addition, an X-axis encoder component 162 is is mounted to the X-axis cross member 116.

The body 152 extends from the lower part 154 and around the edge 134 (FIG. 4), with the upper part 156 spaced above and extending over the upper side 104 of the X-axis base 102 (FIG. 2). The upper part 156 has a cross member mounting surface 158 with apertures 160 to receive the fasteners 117 (FIG. 1) to mount the X-axis cross member 116. As also shown in FIG. 1, an optional nut plate 166 can be positioned between the X-axis cross member 116 and the fasteners 117 to assist in reducing the effect of torque of the fasteners 117 affecting alignment between X-axis drive frame 114 and X-axis cross member 116 as they are tightened.

In some implementations, the X-axis drive frame 114 is also machined in a single set up. Specifically, the casting is secured in a fixture and the bearing mounts 159 are machined, and then the casting is rotated about the Z axis, with no other changes to its position, to allow the cross member mounting surface 158 to be machined. As a result of the single set up machining, positions of the cross member mounting surface 158 and apertures 160 can be determined with greater accuracy and without the tolerance stack-up that would result in a conventional sequence of machining operations in which the casting was released from the fixture after each intermediate step.

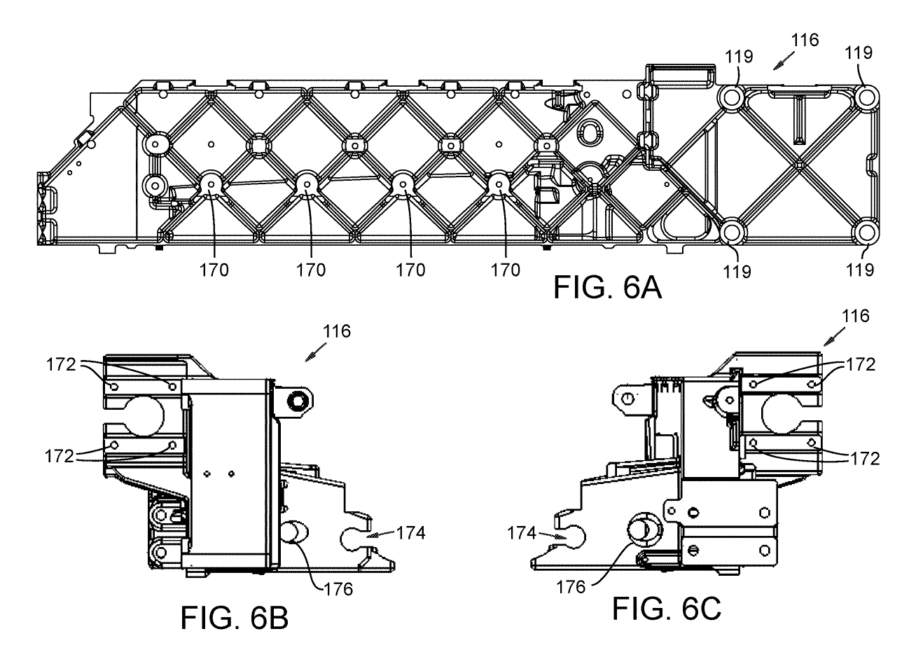

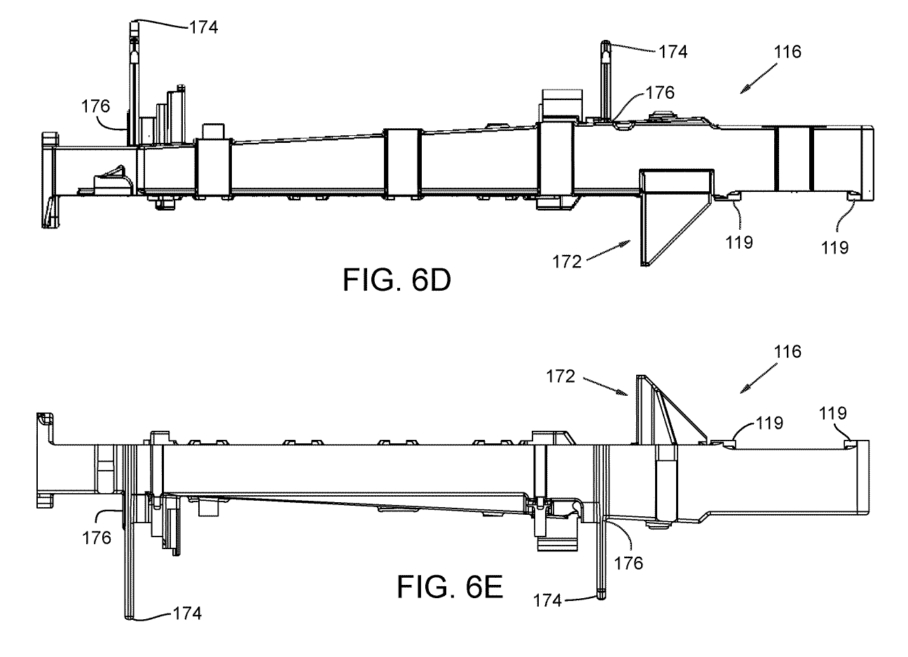

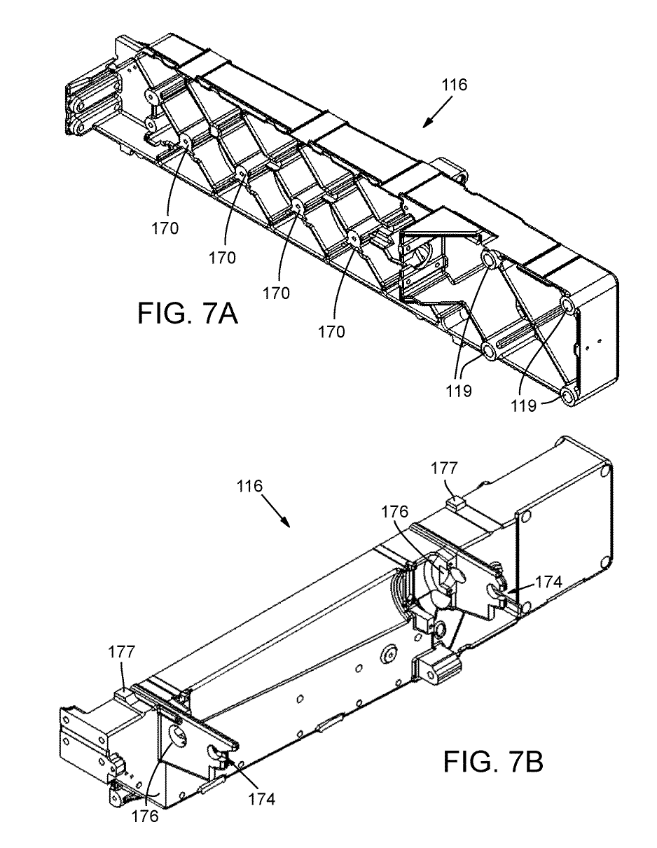

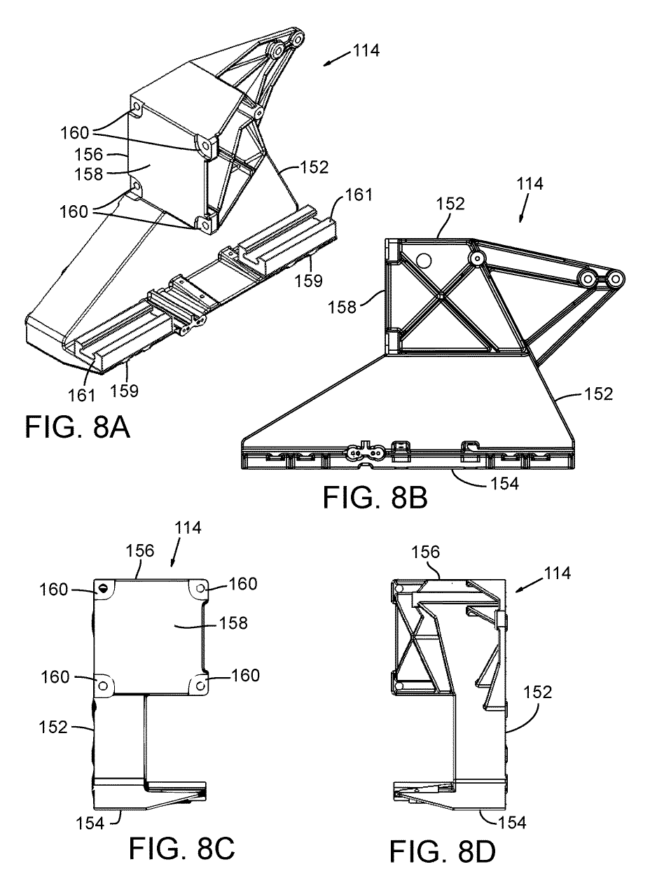

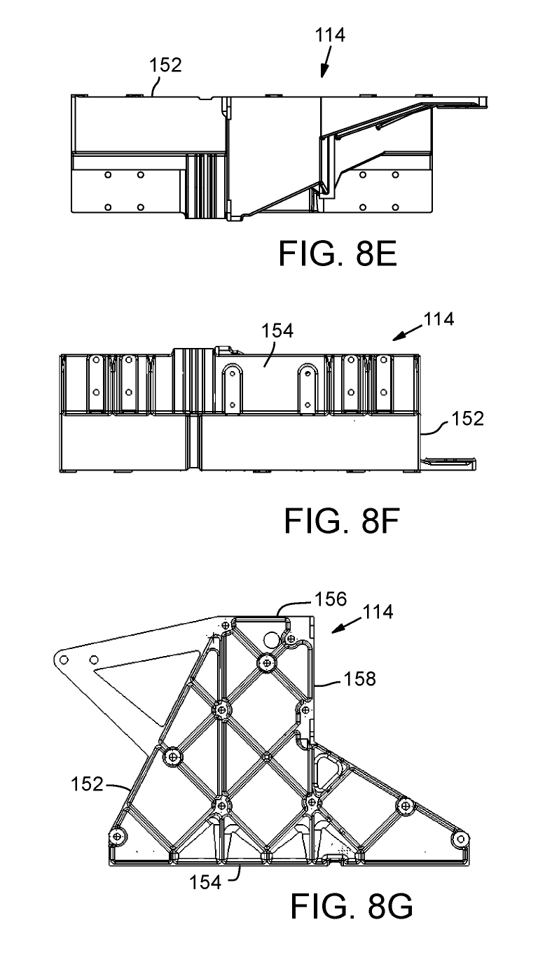

The X-axis cross member 116 is shown in more detail in FIGS. 6A-6E, 7A and 7B. As shown in, e.g., FIG. 6A, the X-axis cross member 116 has a mounting surface with apertures 119 for alignment with the mounting surface 158 and apertures 160 (FIG. 8A) of the X-axis drive frame 114. Before the fasteners 117 are tightened, the X-axis cross member is precisely positioned above the upper surface 104 of the X-axis base 102, such as by using the datum transfer members 180 as described above and shown in FIGS. 9 and 10A.

The X-axis cross member 116 can be also be machined in a single set up. One or more of the following locations can be defined, such as by machining the casting at precisely determined locations, including: (1) a Y-axis linear rail mounting location formed to extend through the projecting bosses 170; (2) Y-axis drive motor mounting locations 172; (3) planerizer blade mounting locations 174; (4) planerizer roller mounting locations 176; and (5) bosses 177 for planerizer gap control and alignment. The X-axis cross member 116 may be rotated about its Z-axis, without other changes to its position, to allow one or more of these sets of locations to be precisely located while minimizing tolerance stack-up. In particular, tolerances are reduced compared to conventional multi-step machining approaches.

A planerizer roller 192 is shown in section FIG. 10B. The planerizer roller 192 is controlled to roll over and precisely smooth, or “planerize,” material that has been deposited on the build plate 190 during a build sequence. The planerizer blade, which is omitted for clarity of illustration, is mounted to be pivotable into contact with an outer cylindrical surface of the planerizer roller 192.

As shown in FIG. 10A, in some implementations, the position of the planerizer roller 192 as installed can be precisely aligned with the a lower surface 194 of the printhead P because the planerizer roller mounting locations 176 on one side of the X-axis cross member 116 and the bosses 170 for the Y-axis linear rail mounting location on an opposite side of the X-axis cross member 116 were machined in a single setup.

In some implementations, because (1) the planerizer roller 192 is precisely located on the X-axis cross member 116, (2) the X-axis cross member 116 is precisely aligned using the bosses 177 and calibration members 180 as discussed above at locations machined into the X-axis base 102, (3) the Z-axis base 108 is positioned at locations machined into the X-axis base 102, then the planerizer roller 192 is also aligned relative to the build plate 190 that travels with the Z-axis stage 110 on the Z-axis base 108.

The flexure assembly 122 (FIG. 2) is mounted at the opposite end of the X-axis cross member 116 and extends downwardly along the edge 136 and inwardly along the lower side 106 to slidably couple X-axis cross member 116 to a rail received in the second rail location 133. The flexure assembly 122 is designed to accommodate variation in the Y direction, including rails that are not exactly parallel. In some implementations, the flexure assembly can accommodate differences in the Y direction of −0.5 mm to +0.5 mm.

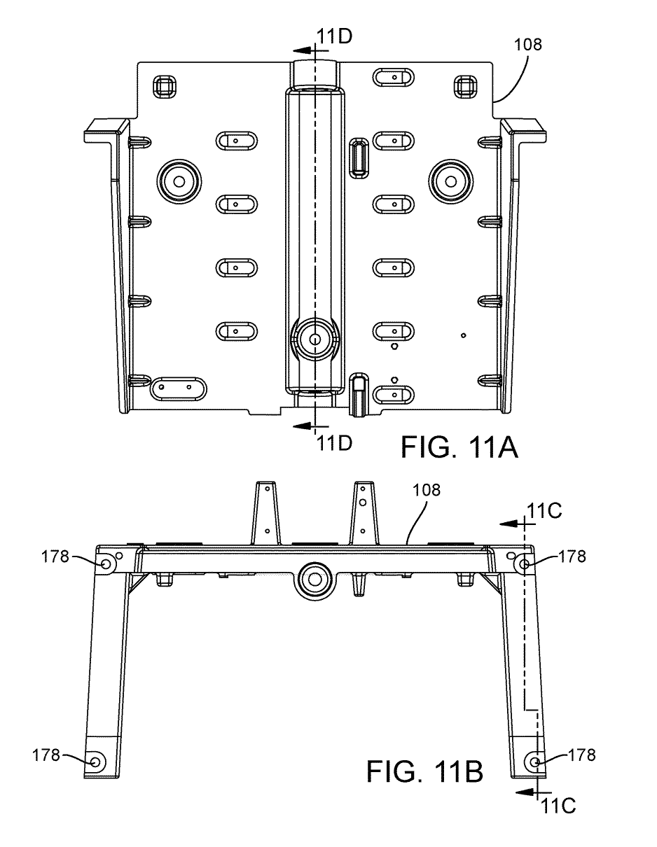

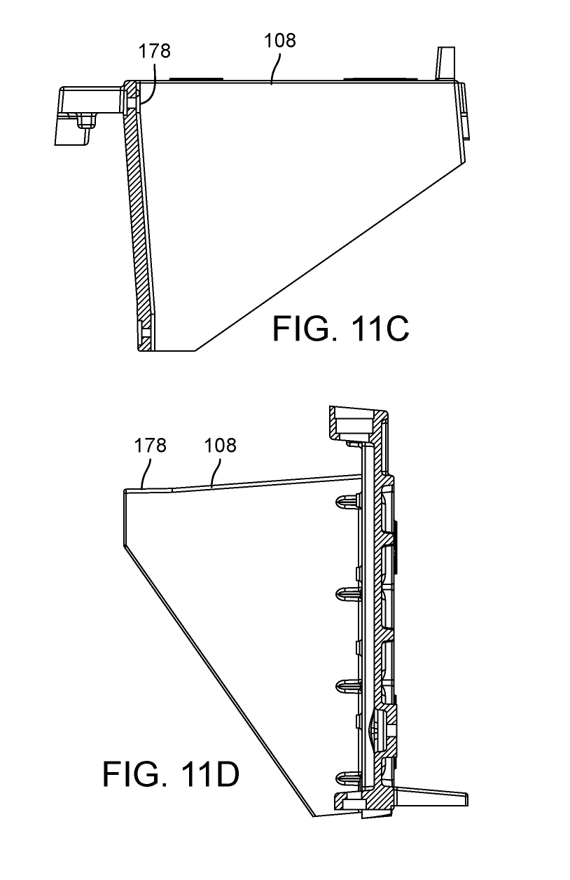

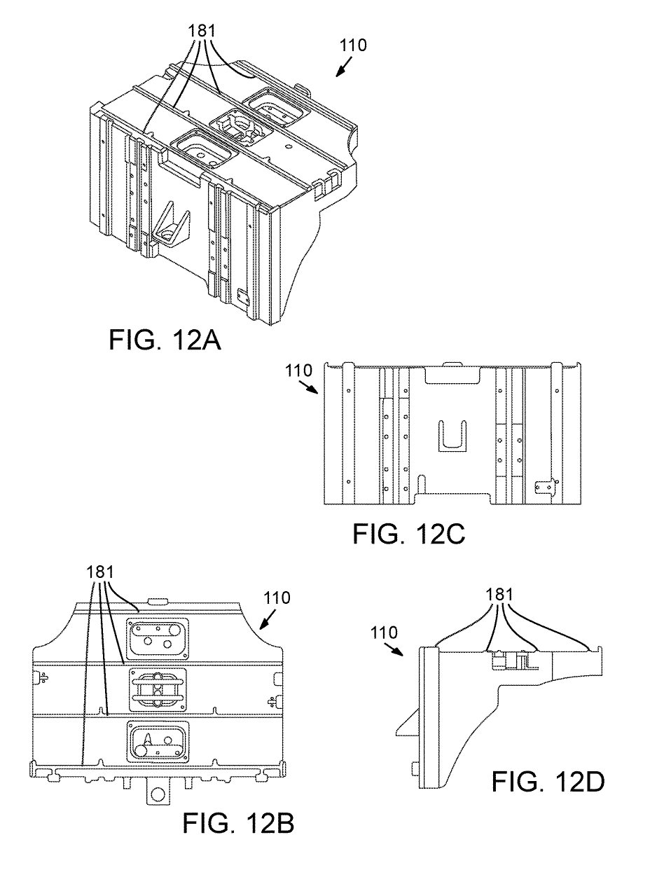

Referring to FIGS. 11A-11D, additional views of the Z-axis base 108 are shown. As can be seen, the Z-axis base 108 has mounting locations, such as mounting apertures 178, for fasteners to attach it to the X-axis base 102 at the attachment locations 138. The Z-axis stage 110, which is shown in greater detail in FIGS. 12A-12D, is mounted to the Z-axis base 108 for movement relative to the Z-axis base 108 in the Z direction. An upper surface 181 of the Z-axis stage 110 can be fitted with the build plate 190 (FIG. 10B) shaped approximately the same size as the opening 118. In the illustrated implementation, discrete contact areas, such as the four contact areas as shown, together comprise the upper surface 181. The contact areas may be machined such that have the desired planarity. During operation, material is deposited upon the build plate 190 to begin the process of constructing or printing a model. As required, such as when subsequent layers are added, the Z-axis stage 110 is moved in the Z direction.

According to a representative method or manufacture and assembly according to the new approach, the following steps are performed:

(1) fix the X-axis base 102 casting in place in a single set up with its lower side 106 exposed (for example, as shown in FIG. 4) for machining.

(2) while the X-axis base 102 is in the single set up, machine the bosses that define rail locations 132, 133.

(3) while the X-axis base 102 is in the single set up and from the same side, machine the Z-axis base attachment locations 138 (e.g., attachment pads).

(4) while in the X-axis base 102 is the single setup and from the same side, machine the datum transfer openings 180 and install the plates 182.

(5) while in the X-axis base 102 is in the single setup and from the same side, machine suitable clamp pads and/or other similar structures.

(6) while in the X-axis base 102 is in the single setup and from the same side, machine one or more of the following: (a) one or more X-axis motor mount locations 142; (b) an X-axis motor belt tension spring location 144; (c) an X-axis belt tensioner location 146; (d) a compound pulley location 148; and (e) a compound pulley bracket location 150.

(7) install the rails or similar guidance members to the X-axis base along the rail locations 132, 133, such as with fasteners. The alignment of the rails may be slightly out of parallel relative to each other. Slight misalignment can be accommodated with use of the flexure 122 or other similar approach.

(8) install the Z-axis base 108 to the X-axis base 102.

(9) install the Z-axis stage 110 to the Z-axis base 108.

(10) at the same time or at different time, machine the X-axis drive frame 114 casting in a single setup. Machine the bearing mounts 159, rotate the casting about its Z axis with no other changes to its position, and machine the mounting surface 158 and apertures 160.

(11) at the same time or at different time, machine the X-axis cross member 116 casting in a single setup. One or more of the following locations can be defined, including (a) a Y-axis linear rail mounting location formed to extend through the projecting bosses 170; (b) Y-axis drive motor mounting locations 172; (c) planerizer roller mounting locations 176; and (d) planerizer blade mounting locations 174. Rotate the X-axis cross member 116 180 degrees while in the single set up to expose it opposite side for machining the planerizer blade mounting locations 174 and the planerizer roller mounting locations 176.

(12) reposition the X-axis base 102 as necessary to expose the opposite (upper) side. Position the X-axis drive frame 114 along one edge and couple it to its corresponding rail. Position the X-axis cross member 116 along the opposite edge and loosely couple it with the flexure assembly 122 to its corresponding rail.

(13) with the calibration members in place in the datum transfer openings, rest the X-axis cross member 116 on the calibration members, align it with the X-axis drive frame 114 (using the optional nut plate 166, if desired), tighten the fasteners 117 and then fixture the flexure assembly 122 with fasteners.

(14) mount the planerizer roller 192 to the planerizer roller mounting locations 176 on the X-axis cross member 116.

(15) mount the planerizer blade to the planerizer blade mounting locations 174 on the X-axis cross member 116.

(16) mount the Y-axis linear rail to the X-axis cross member along the Y-axis rail location. Couple the Y-axis carriage 124 to the Y-axis linear rail. The Y-axis carriage 124 includes the printhead P.

(17) achieve the desired printhead P (mounted to Y axis carriage 124) to planerizer roller 192 (mounted to X-axis cross member 116) alignment without further adjusting relative positions of planerizer and printhead P because X-axis cross member 116 was machined in a single setup (so planerizer roller mounting locations 176 and the Y-axis linear rail location were precisely determined in the single set up) and datums for mounting printhead P in Y-axis carriage 124 are also machined precisely.

(18) achieve the desired build plate (mounted to Z axis stage 110) to planerizer roller 192 (mounted to X-axis cross member 116) alignment without further adjusting relative positions of build plate 190 and planerizer blade because X-axis cross member 116 was machined in a single setup (so planerizer roller mounting locations 176 were precisely determined in the single set up), the position of the X-axis cross member relative to the X-axis base 102 was precisely determined, and the Z-axis base 108 to which the Z-axis stage 110 and build plate 190 are coupled was machined in a single set up with the rail locations 132, 133 locating the X-axis cross member 116.

### GENERAL CONSIDERATIONS

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Some of the figures provided herein include an orientation system that includes an x-axis, a y-axis, and a z-axis that are mutually orthogonal to one another. It should be understood that the orientation system is merely for reference and can be varied. For example, the x-axis can be switched with the y-axis and/or the object or assembly can be rotated.

In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

What is claimed is:

1. A method of assembling precision components of a 3D printing system, comprising:
providing an X-axis base configured for positioning stationarily relative to movable Y-axis and Z-axis components, the X-axis base having a first side, an opposite second side and at least one datum transfer through opening extending from the second side to the first side, the datum transfer opening having a generally planar peripheral surface on the second side defining an XY reference plane;
providing a cover member on the second side to at least partially cover the datum transfer through opening, the cover member fitting against at least a portion of the generally planar peripheral surface of the datum transfer through opening and together with a wall of the opening defining a bore in the X-axis base;
placing a calibration member having a predetermined dimension in the bore, the calibration member being sized to contact the cover member and project above the first side of the X-axis base; and
positioning a second component to contact the calibration member, thereby locating the second component at a position spaced from the XY reference plane by the known dimension.

2. The method of claim 1, wherein the datum transfer through opening is a first datum transfer through opening, further comprising providing at least a second datum transfer through opening in the X-axis base spaced apart from the first datum transfer through opening, a second calibration member and a second cover member, and wherein positioning a second component comprises positioning the second component to contact the calibration member in the first datum transfer through opening and the second calibration member in the second datum transfer through opening.

3. The method of claim 1, wherein the second component comprises an X-axis cross member movable relative to the X-axis base in an X direction.

4. The method of claim 3, wherein the second component comprises an X-axis drive frame coupleable to the X-axis cross member with fasteners, further comprising tightening the fasteners to secure the X-axis cross member to the X-axis drive frame after the X-axis cross member is positioned.

5. The method of claim 1, further comprising forming the datum transfer through opening at a predetermined location during a machining operation conducted while the X-axis base is secured with the second side exposed.

6. The method of claim 5, wherein the predetermined location is a feature in a casting of the X-axis base.

7. A method of assembling precision components of a 3D printing system, comprising:
providing an X-axis base configured to be positioned stationarily relative to movable Y-axis and Z-axis components in an assembled 3D printing system, the X-axis base having a first side, an opposite second side and a workpiece opening defined therein to extend between the first and second sides;
securing the X-axis base for machining in a single setup with the second side exposed for machining;
while the X-axis base is secured in the single set up, machining Z-axis base mounting locations at predetermined positions adjacent the workpiece opening, the Z-axis base mounting locations being configured for mounting a Z-axis base that supports a model being printed and moves the model relative to the X-axis base in a Z direction; and
while the X-axis base is secured in the single set up, machining at least one rail location defining an X direction along which a movable member can be moved to cause a printhead coupled to the movable member to print in the X direction, wherein at least the X direction and the Z direction are defined while the X-axis is in the single setup, thereby reducing potential loss of precision in positioning due to tolerance stack-up.

8. The method of claim 7, wherein the at least one rail location is a first rail location, further comprising, while the X-axis base is secured in the single set up, defining a second rail location generally parallel to and spaced apart from the first rail location.

9. The method of claim 7, further comprising defining a Y direction feature on the movable member to allow the printhead coupled to the movable member to move in the Y direction.

10. The method of claim 7, wherein the movable member comprises an X-axis cross member, further comprising machining the X-axis cross member in a single setup to have a Y direction feature on a first side for guiding movement of the printhead, and, while secured in the single setup and rotated 180 degrees, machining a second side of the X-axis cross member to have mounting features for at least one of a planerizer and a planerizer blade.

11. The method of claim 10, wherein the Y direction feature is a rail location for securing a rail along which the printhead can travel in the Y direction.

12. The method of claim 10, further comprising machining a Y-axis drive motor location on the second side of the X-axis cross member.

13. The method of claim 7, wherein the movable member comprises an X-axis drive frame, further comprising machining the X-axis drive frame in a single setup to have bearing mount locations for bearing mounts that slidingly couple the X-axis drive frame to the X-axis base and a mounting surface to which an X-axis cross member can be attached.

14. The method of claim 7, further comprising, while the X-axis base is secured in the single setup, machining the X-axis base the first side to define at least one of the following: one or more X-axis motor mount locations, an X-axis motor belt tension spring location, an X-axis belt tensioner location, a compound pulley location and a compound pulley bracket location.

15. A 3D printing system, comprising:
an X-axis base configured to be positioned stationarily relative to movable Y-axis and Z-axis components, the X-axis base having a first side, an opposite second side and a workpiece opening defined therein to extend between the first and second sides;
a Z-axis base secured to the second side of the X-axis base adjacent the workpiece opening, the Z-axis base being configured to support a model being printed and to controllably move the model in a Z direction through the workpiece opening in the X-axis base; and
a movable arm member slidingly coupled to the second side of the X-axis base and extending over the first side of the X-axis base, the movable arm being movable in an X direction;
a Y-axis carriage slidingly coupled to the movable arm member and being movable in a Y direction;
a printhead coupled to the Y-axis carriage, wherein the printhead is controllably movable in the X direction by movement of the movable member and in the Y direction by movement of the Y-axis carriage to print successive layers of the model supported by the Z axis base.

16. The 3D printing system of claim 15, wherein the movable member comprises an X axis drive frame slidingly coupled to a first rail at a first rail location on the second side and an X-axis cross member slidingly coupled to a second rail at a second rail location spaced apart from the first rail location, and wherein the X-axis drive frame and X-axis cross member are coupled together according to a predetermined spacing from a reference surface.

17. The 3D printing system of claim 16, further comprising a planerizer roller coupled to the X-axis cross member, and wherein the planerizer roller position on the X-axis cross member and features on the X-axis cross member defining the Y direction of the Y-axis carriage movement are defined while the X-axis cross member is machined in a single setup.

18. The 3D printing system of claim 16, further comprising a planerizer roller coupled to the X-axis cross member, and wherein a position of a tangent to the planerizer roller is established precisely relative to a position of a build plate on which the model is supported within the Z-axis base.

19. The 3D printing system of claim 18, further comprising a Z-axis stage that contacts and moves the build plate, the Z-axis stage being movably coupled to the Z-axis base.

20. The 3D printing system of claim 16, wherein the X-axis cross member is coupled to the second rail with a flexure member to accommodate a predetermined amount of lack of parallelism between the first and second rails.
